(19) United States
(12) Patent Application Publication
(10) Pub. No.: US 2007/0085327 A1
(43) Pub. Date: Apr. 19, 2007

(54) Folder with removable bookmark

(75) Inventor: Steve Russo, Brooklyn, NY (US)

Correspondence Address: GOTTLIEB RACKMAN & REISMAN PC, 270 MADISON AVENUE, 8TH FLOOR, NEW YORK, NY, 100160601, US

(73) Assignee: Fashion Accessory Bazaar LLC

(21) Appl. No.: 11/378,970

(22) Filed: Mar. 17, 2006

Related U.S. Application Data
(60) Provisional application No. 60/718,104, filed on Sep. 16, 2005.

(51) Int. Cl. B42D 1/00

(52) U.S. Cl. 281/21.1

(57) ABSTRACT

The present invention provides a folder into which an appendage is created on the interior surface of the folder's pocket. The appendage is tab-like and may be removed from the inside pocket. The appendage is formed so that after it is removed, it may be used as a separate bookmark, picture or note sheet. Preferably graphics are provided on the appendage which may complement or coordinate with graphics elsewhere on the folder. The folder may have one or more appendages. Perforations are provided to enable the appendage to be removed by tearing off the appendage from the surface of the pocket.

This application claims priority of Provisional Application No. 60/718,104.

### BACKGROUND OF THE INVENTION

Folders for holding papers and the like are well known. However, there is little to differentiate one folder from another in terms or marketability of the folder. The present invention overcomes this problem by providing an incentive for buying the folder.

### SUMMARY OF THE INVENTION

The present invention provides a folder into which an appendage is created on the interior surface of the folder's pocket. The appendage is tab-like and may be removed from the inside pocket. The appendage is formed so that after it is removed, it may be used as a separate bookmark, picture or note sheet. Preferably graphics are provided on the appendage which may complement or coordinate with graphics elsewhere on the folder. The folder may have one or more appendages. Perforations are provided to enable the appendage to be removed by tearing off the appendage from the surface of the pocket.

Accordingly, it is an object of the invention to provide an improved stationery folder.

### BRIEF DESCRIPTION OF THE DRAWINGS

Reference is made to the following description in which:

FIG. 1 is a front perspective view of a folder according to the present invention, showing the folder open, with a single appendage; and

FIG. 2 is a front perspective view of a folder according to the present invention, showing the folder open, with multiple appendages.

### DETAILED DESCRIPTION OF THE INVENTION

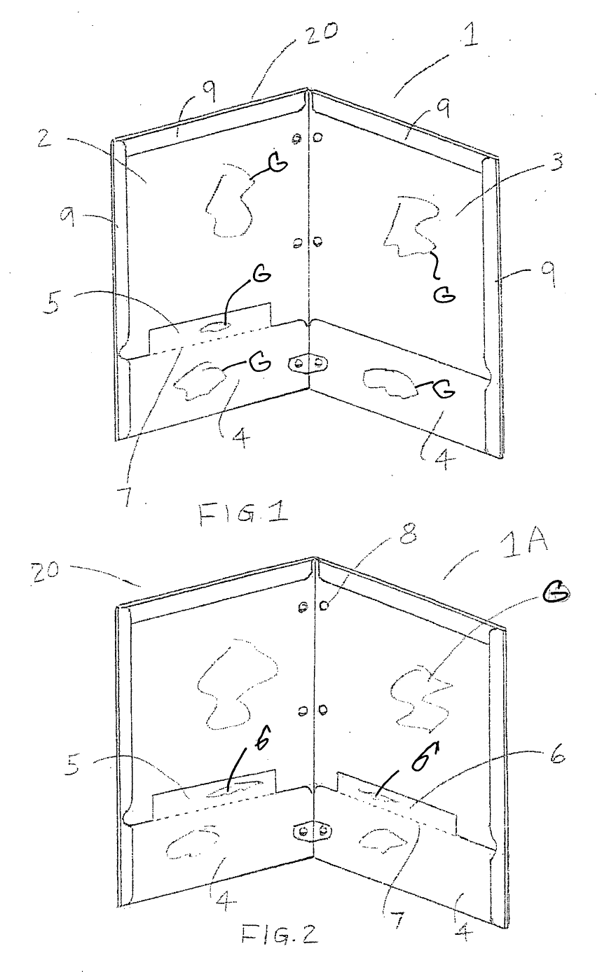

FIG. 1 illustrates a folder 1 according to the present invention. Folder 1 includes a front panel 2 and a rear panel 3. Pockets 4 are provided, with the pockets formed from the same sheet of material that the rest of folder 1 is fabricated from.

Pockets 4 are formed by side flaps 9 that are glued to the interior surfaces of panels 2 and 3, allowing the pockets to receive papers, written materials, photographs or the like that may be inserted into the pockets by a user. The pockets may be of any height, although it is typical that the pockets be of a height less than half of the height of panels 2 or 3.

Pocket 4 is formed to include a tab-like appendage 5 which is formed from the sheet of material forming the pocket. Appendage 5 can be of any dimension that can be formed from the sheet. Tear perforations 7 are provided to enable appendage 5 to be cleanly removed from pocket 4 by tearing off the appendage along the perforation line.

Appendage 5, once removed, may be used as a bookmark, picture or note sheet. In order to enhance the marketability of the folder, appendage 5 may have graphics G which may coordinate with, or be complementary to, graphics G elsewhere on the folder, for example, graphics G on folder panels 2 and/or 3 and/or graphics G on pockets 4. For example, appendage 5 may be a bookmark with flowers on it, and these flowers may complement flowers on the inside or outside of the rest of the folder.

FIG. 2 illustrates a folder 1A, similar to folder 1 shown in FIG. 1. However, folder 1 A includes two tab-like appendages, 5 and 6, formed from the sheet of material that forms the pockets and the rest of the folder. Again, appendage 6 may include graphics G (which may be the same or different from the graphics on appendage 5), allowing the same or different pictures or note surfaces to be provided for the end user. The graphics G may be coordinated with, or complement, other decorations of graphics, for example, on the exterior surface 20 of the folder.

Folder 1 and folder 1A may include perforated holes 8 for attaching a binder as typical in many uses, or the folders may be constructed without holes. As well, the folders may be made of different sizes, size being a matter of choice. By forming the appendages from the same sheet of material as the pocket, manufacturing efficiency and cost savings are also provided.

The scope of the invention is now indicated in the claims.

1. A stationery folder comprising:
at least one panel and an integrally formed sheet element for defining a pocket; and
an appendage tab foldably attached to said sheet element for defining a tear line.

2. The stationery folder of claim 1, wherein said fold line is perforated.

3. The stationery folder of claim 1, wherein said sheet element has bottom and side edges attached to said panel and a top edge to which said appendage tab is foldably attached.

4. The stationery folder of claim 3, wherein said pocket has an entrance thereinto defined by said top edge of said sheet element.

5. The stationery folder of claim 1, wherein said appendage tab is selected from the group consisting of a book mark and note sheet.

6. The stationery folder of claim 1, wherein said appendage tab depicts a graphic design which coordinates with and is complementary to a graphic design displayed on at least one of said panel and said sheet element.

7. The stationery folder of claim 1, wherein said at least one panel comprises a pair of panels foldably connected alongside edges thereof.

8. The stationery folder of claim 7,wherein each said panel has an integrally formed sheet element associated therewith for defining a pair of pockets.

9. The stationery folder of claim 8, wherein each said sheet element has a free edge to which an appendage tab is foldably attached.

10. The stationery folder of claim 9, wherein one of said appendage tabs depicts a first graphic design complementary to and coordinating with a graphic design displayed on one of said panels and the other of said appendage tabs depicts a second different graphic design that is complementary to and coordinating with a graphic design displayed at the other of said panels.

11. The stationery folder of claim 10, wherein each of said panels is formed with at least one hole adjacent to one side edge thereof.

12. The stationery folder of claim 11, wherein said holes of each said panel are in alignment with each other when said panes are folded together.
